(19) United States
(12) Patent Application Publication
(10) Pub. No.: US 2010/0154418 A1
(43) Pub. Date: Jun. 24, 2010

(54) Solar energy from the volume change of water

(76) Inventor: Edwin Newman, Palmdale, CA (US)

Correspondence Address: EDWIN NEWMAN, 2854 NANDINA DR., PALMDALE, CA, 93550, US

(21) Appl. No.: 12/455,639

(22) Filed: Jun. 5, 2009

Related U.S. Application Data
(60) Provisional application No. 61/203,101, filed on Dec. 19, 2008.

(51) Int. Cl. F03G 6/00

(52) U.S. Cl. 60/641.15

(57) ABSTRACT

Water expands in volume when it is heated up and contracts in volume when when heat is taken out of it. This invention relates to systems where solar energy causes volume changes in water so electrical energy is thereby produced. In a first preferred embodiment a field of solar mirrors concentrate solar energy on two targets alternately. Pipes feeding pressure to either side of a common piston are thereby energized alternately causing reciprocal movement of the piston. Through a gear mechanism an generator is then energized to produce electricity. In a second preferred embodiment the sun shines directly on a large bourdon tube. In a day temperature rises and falls. This causes the bourdon tube to coil and uncoi, energizing attached gearing and an electrical generator.

### This invention is a Continuation-in Part of Provisional Patent application No. 61/203,101 filed Dec. 18, 2008.

### BACKGROUND OF THE INVENTION

a. Field of the Invention

This invention relates to systems for generating electricity from solar energy an more specifically solar thermal systems which need no turbines.

b. Description of the Prior Art

In central tower solar thermal systems solar energy is made to heat up a fluid which is made to operate a gas turbine. Several of these turbines need to be installed for each generator operated so if one turbine has down time for maintenance the other turbine can be made to continue power production.

Also, in the field of solar energy conversion, present systems only work in daylight. And whether photovoltaic or solar thermal systems are used the system efficiency is rather low.

The use of bourdon tubes in electric power systems is known but has limited use. In my U.S. Pat. No. 6,781,253 seawater is compressed and decompressed according to wave action offshore. The resulting pressure variation is transmitted ashore by a pipe. Since water has insignificant internal energy loss this pressure variation is transmitted very efficiently and at the speed of sound through seawater, which is much faster than the speed of sound through air. The pressure variation causes a bourdon tube to change shape and activate gearing which in turn is made to operate an electric generator.

An object of this invention is to eliminate the need for a turbine in a solar thermal energy conversion system.

Another object is to provide a solar energy conversion system capable of providing power day and night without the need for storage.

### SUMMARY OF THE INVENTION

The invention related to solar thermal energy conversion systems where solar energy is either concentrated or not concentrated.

In the first preferred embodiment a field of solar mirrors are con configured to aim at either of two solar energy targets alternately. Each target is filled completely with water. At their lower ends thin pipes are made to connect these reservoirs of water to a common piston which in its turn is made to operate gearing to operate an electric generator. The common field of mirrors is focused one one target until the water in it is heated up to a predetermined temperature and then the mirrors are focused on the other target. So as one reservoir of water is heated up the other one cools down, constantly operating the piston and connected generator. At night the pipes and gearing are arranged so the fall in temperature until dawn causes the piston to be moved. And so the electric generator is further operated.

In the second preferred embodiment a bourdon tube is shaped as a certain helical form so its fixed central pole may be a transmission power pole, a telephone pole, a street lamp pole, a wind energy conversion system pole. Built along a seacoast pressure within the bourdon tube may be further varied by wave action offshore through the agency of a pipe between the wave field and the bourdon tube. The bourdon tube itself contains heat pipes to transmit temperature into colder areas of the water volume. As the daily temperature rises and falls the bourdon tube uncurls and curls respectively. This action causes a gear rack on the tip of the bourdon tube to operate a pinion gear and one or several speed changers which in turn are made to operate an electric generator. Wind chill and intermittent cloud cover will increase power production. For frigid zones antifreeze is added to the water.

The attainment of the foregoing and related objects, advantages and features should be more readily apparent to those skilled in the art after review of the following more detailed description of the invention, taken together with the drawings in which:

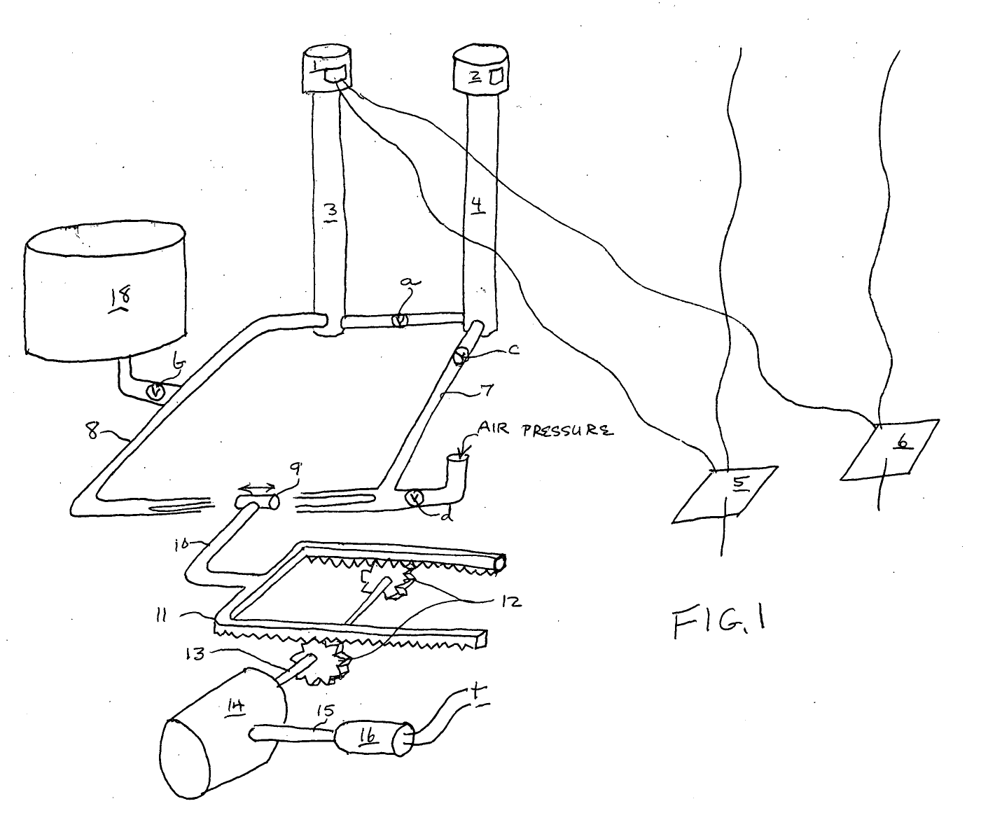

FIG. 1 is a perspective view of the first preferred embodiment of the invention,

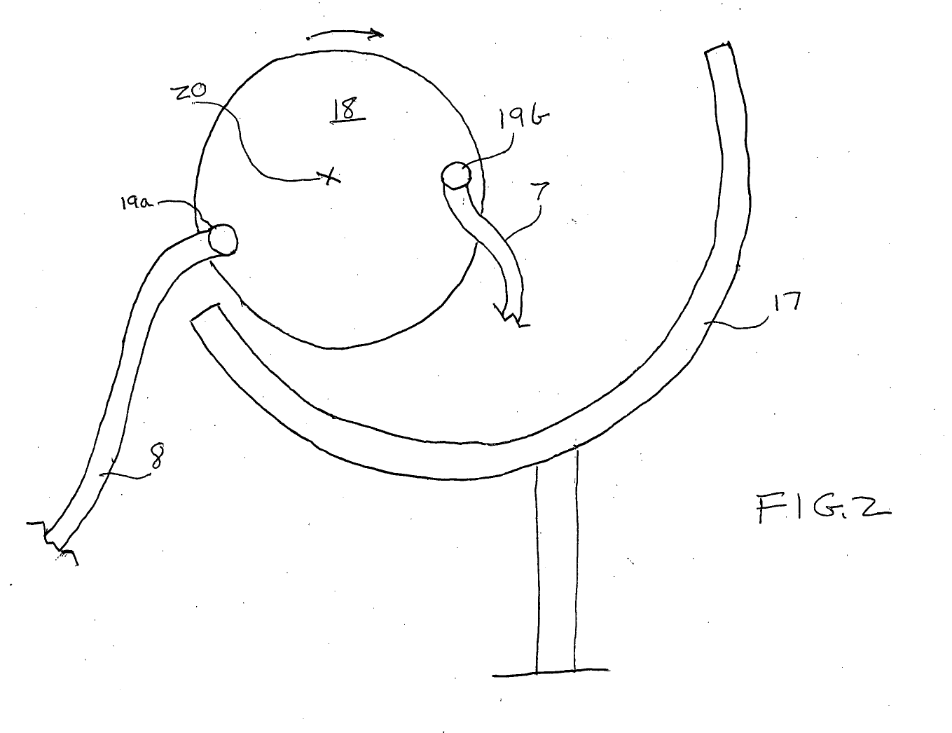

FIG. 2 is a perspective view of the first preferred embodiment of the invention as applied to trough type mirrors.

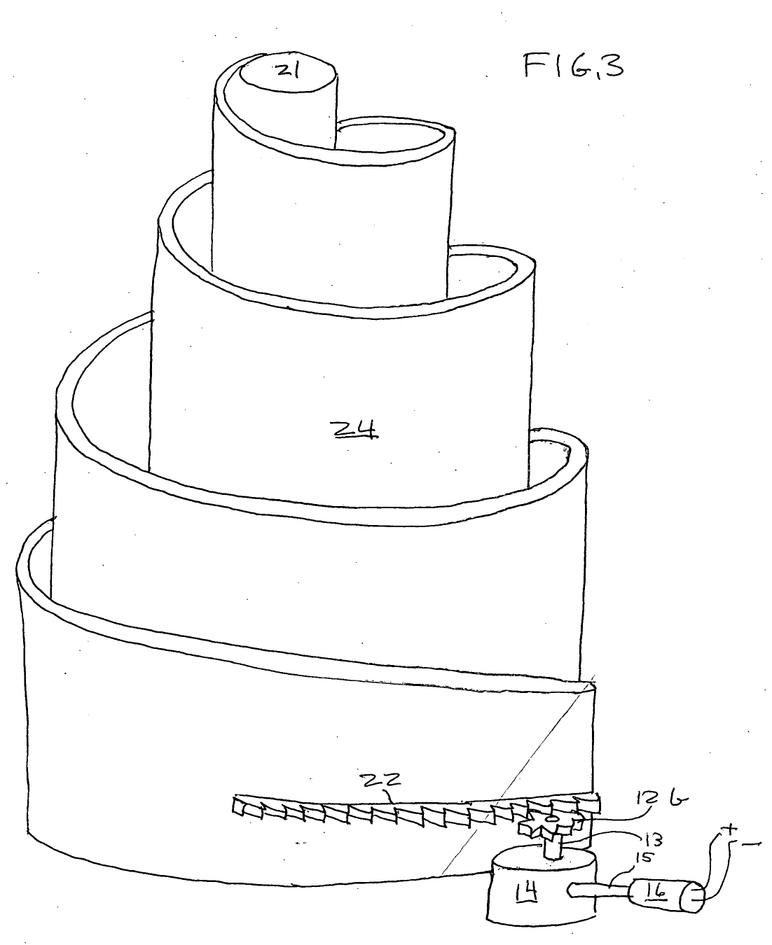

FIG. 3 is a perspective view of the second preferred embodiment of the invention.

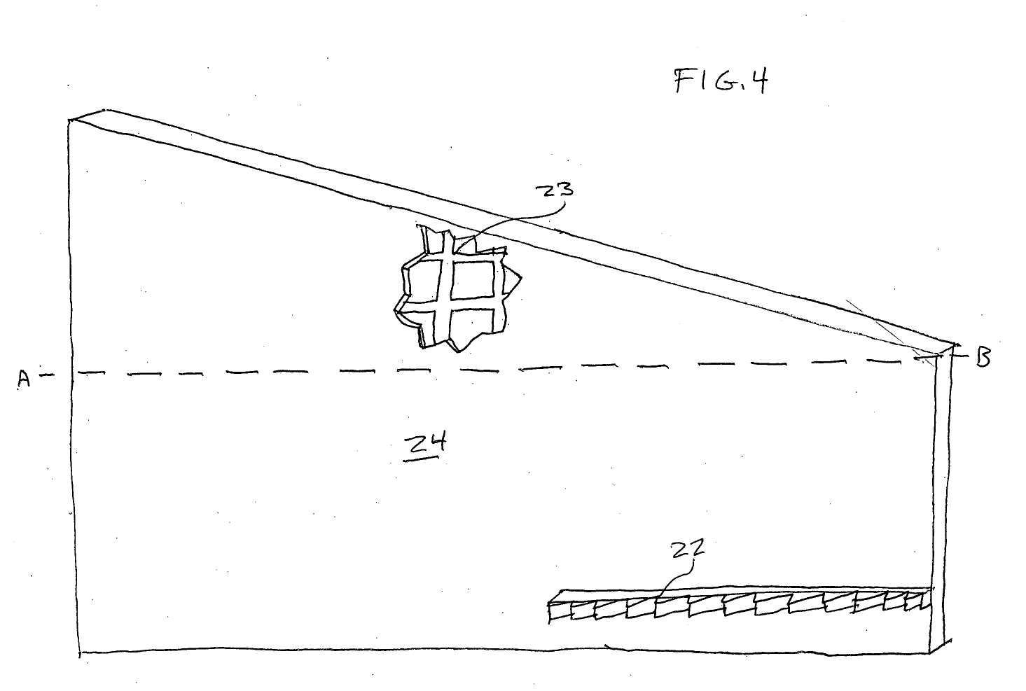

FIG. 4 is a side view of a bourdon tube according to the invention which is rolled out flat to better show its shape and structure.

### DETAILED DESCRIPTION OF THE INVENTION

Turning to FIG. 1 we see two closed targets completely filled with water 1,2. These function as solar thermal towers. The water in them is made to move only minimally. These targets are elevated by tower supports 3,4. Solar mirrors 5,6 cause the wa water in these targets to be heated up by agency of a focusing mechanism known in the prior art. Pipes 7,8 are made to transmit pressure from the volumes of water within pipes 7,8 to opposite surfaces of piston 9. A gear rack 11 is connected by shaft 10 to piston 9. Pinion gear 12 is made to mesh with rack 11 and operate electrical generator 16 through the agency of shafts 13,15 and speed changer 14. The gearing is taken from U.S. Pat. No. 25,550. Unlike a cam, this gearing will be operated regardless of the length of the stroke. This is important as in any renewable energy system energy input is erratic.

In operation, solar energy is reflected by mirrors alternately to targets 1,2 so as water from one target is heated up the water in the other target is made to cool down. The piston 9 is thus made to move in a reciprocal manner, operating the gearing and electric generator.

In FIG. 2 we see trough type mirrors 17. instead of a field of parabolic mirrors and a central tower. Two focus tubes 19a,b are made to rotate and switch positions periodically around pivot 20.

At night valves a,b d are opened and valve c is closed. The presence of reservoir 18 filled with water will cause piston 9 to be moved further with each degree of temperature change. If the pipes and target reservoirs are completely filled wi with water and targets 1,2 are less than 32 ft. off the ground then air pressure at ground level and through valve d will push piston 9 as the water volume contracts and the temperature goes down. This invention thus becomes an atmospheric engine which is made to further operate generator 16.

In a second preferred embodiment we see as in FIG. 4 a semi-helical bourdon tube rolled flat. The central pole is on the left hand larger vertical side. A system of heat pipes is partially shown as an internal structure 23.

In operation, that part of the tube below line AB is the effective area applying force to the tip surface on the right side of the drawing. That part of the tube above line AB is always exposed to the sun in daylight and thus is made to aid the heat pipes in distributing heat throughout the water volume within the tube. FIG. 3 shows this semi helical bourdon tube 22 disposed around central pole 21. Gear rack 22 fixedly attached to the tip are af the tube is made to mesh with pinion gear 12b.

Generator 16 is operatively connected to pinion gear 12b through the agency of shafts 13,15 and speed changer 14. Operation of this gearing occurs as temperature changes throughout the day and night. If this structure is built along a seacoast then a thin pipe may be connected to the bourdon tube from an offshore device in a wave field. Although the pressure differences from ocean waves are small, they are far more frequent that those provided by direct sun. See further U.S. Pat. No. 6,781,253.

From the above description it is apparent that the preferred embodiments achieve the objects of the invention. The above embodiments are provided purely as examples. Many other variations, modifications and applications of this invention may be made. These are considered to be equivalent and within the scope and spirit of the invention.

I claim:

1. A solar energy conversion system comprising:
a. a collection means for collecting solar energy,
b. a directional means for focusing said solar energy,
c. a piston,
d. pipes led from said collection means to the opposite sides of said piston,
e. valves operatively connected to said pipes,
f. an electric generator,and
g. gearing so said electric generator and said piston are operatively connected,
so said solar energy is converted into electrical energy.

2. The system of claim 1 wherein the said collection means is selected from the group of:
a. a field of solar mirrors,and two central solar towers, and
b. through type solar mirrors,

3. The system of claim 1 wherein said pipes and valves further includes a pipe and valve are led to a large closed reservoir of water so said reservoir is operatively connected to said piston.

4. A solar energy conversion system comprising:
a. a large bourdon tube,
b. a system of heat pipes within the water volume inside said bourdon tube so heat is distributed within said water volume,
c. a central pole means to which one end of said bourdon tube is fixedly attached,
d. a gear rack to which a second end of said bourdon tube is fixedly attached,
e. an electric generator, and
f. gearing so said gear rack and said electric generator are operatively connected.
